(19) United States
(12) Patent Application Publication
(10) Pub. No.: US 2009/0176403 A1
(43) Pub. Date: Jul. 9, 2009

(54) Cable assembly

(75) Inventors: Guo-Hua Yang, Kunshan (CN); David Ko, Fullerton, CA (US); Su-Feng Liu, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/319,297

(22) Filed: Jan. 5, 2009

(30) Foreign Application Priority Data
Jan. 5, 2008 (CN) 200820030612.5

(51) Int. Cl. H01R 12/24

(52) U.S. Cl. 439/495; 439/492

(57) ABSTRACT

A cable assembly in accordance with the present invention comprises an insulative housing defining a supporting portion with an upper surface and a pair of fixing portions disposed at two sides of the supporting portion with a top surface higher than the upper surface, and a receiving space defined by the supporting portion and the pair of fixing portions; a flexible flat cable supported by the supporting portion of the insulative housing and received into the receiving space; an upper shell assembled to the insualtive housing and defining a main body portion covering to the flexible flat cable and a pair of positioning portions respectively attached to the pair fixing portions thereof, the upper shell having a recessed main body portion relative to the pair of fixing portions and received into the receiving space; and a pair of latch members respectively mounted on the pair of fixing portions.

### FIELD OF THE INVENTION

The present invention relates to a cable assembly, and more particularly to a cable assembly with a shell securely assembled to an insulative housing thereof and not easily to be divorced from the insulative housing.

### DESCRIPTION OF PRIOR ART

U.S. Pat. Pub. No. US2005/0255742 A1 filed by Shih (hereinafter referred to as Shih '742 Pat. Pub.) on Nov. 17, 2005 discloses a cable assembly 1. Please referring to FIGS. 3 through 7 of the Shih '742 Pat. Pub., it includes a connector housing 10, a flat cable 40 preinstalled on the connector housing 10, a shell 30 covered to the connector housing 10 and compressed the flat cable 40 and a pair of spring clamp 20 mounted on two sides of the connector housing 10. The shell 30 defines several tabs (not labeled) at two sides thereof and respectively attached to the two sides of the connector housing 10. When the cable assembly 1 is in the process of plugging into and pulling out from the complementary connector (not shown), the operator should press the spring clamp 22 inwardly making the spring clamp 22 swung relative to the connector housing 10, at the same time the tabs of the shell 30 will be forced by the spring clamp 22. Thus, the middle portion of the shell 30 will be expanded outwardly and spaced to connector housing 10, so that the shell 30 may be divorced from the connector housing 10 when the spring clamps 22 act on the tabs of the shell 30 by a comparably large inward pressure.

As discussed above, an improved cable assembly overcoming the shortages of existing technology is needed.

### SUMMARY OF THE INVENTION

Accordingly, an object of the present invention is to provide a cable assembly with a shell firmly assembled to the insulative housing and not easily to be separated from the insulative housing.

In order to achieve the above-mentioned objects, a cable assembly in accordance with the present invention comprises an insulative housing defining a supporting portion with an upper surface and a pair of fixing portions disposed at two sides of the supporting portion with a top surface higher than the upper surface, and a receiving space defined by the supporting portion and the pair of fixing portions; a flexible flat cable supported by the supporting portion of the insulative housing and received into the receiving space; an upper shell assembled to the insualtive housing and defining a main body portion covering to the flexible flat cable and a pair of positioning portions respectively attached to the pair fixing portions thereof, the upper shell having a recessed main body portion relative to the pair of fixing portions and received into the receiving space; and a pair of latch members respectively mounted on the pair of fixing portions.

Other objects, features and advantages of the invention will be apparent from the following detailed description taken in connection with the accompanying drawings.

### BRIEF DESCRIPTION OF THE DRAWINGS

FIG. 1 is a perspective view of a cable assembly in accordance with the present invention;

FIG. 2 is an exploded, perspective view of the cable assembly;

FIG. 3 is an exploded, perspective view of the cable assembly in another point of view different from FIG. 2;

FIG. 4 is a partial perspective view of the cable assembly made in accordance with the present invention;

FIG. 5 is a cross section view of the cable assembly of FIG. 1 taken along line 5-5.

### DETAILED DESCRIPTION OF PREFERRED EMBODIMENTS

Reference will now be made to the drawing figures to describe the present invention in detail.

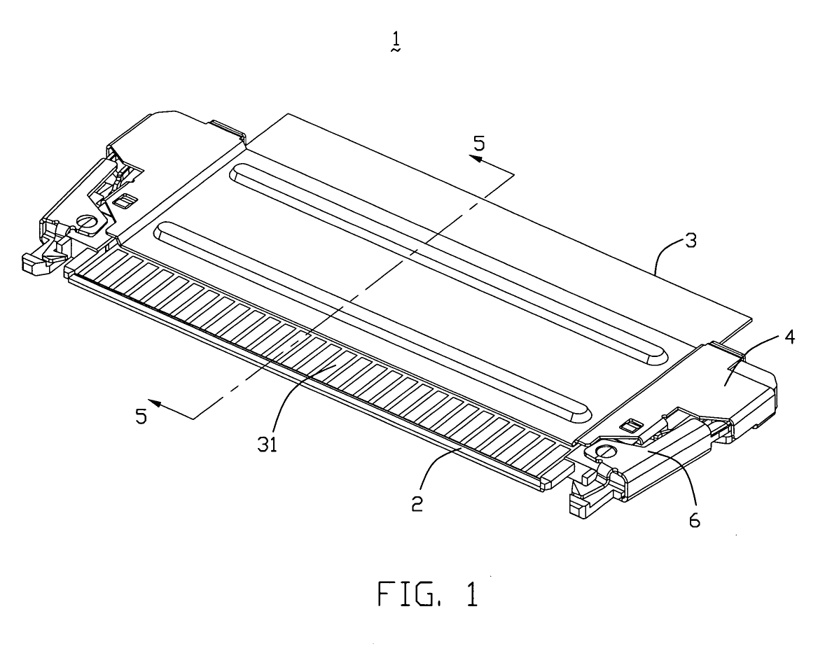

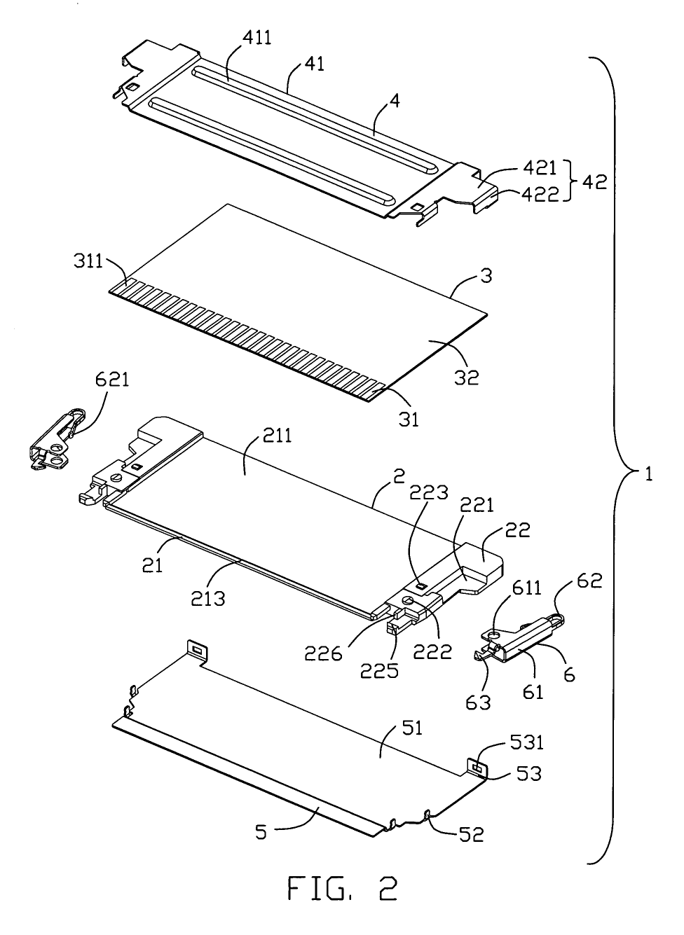

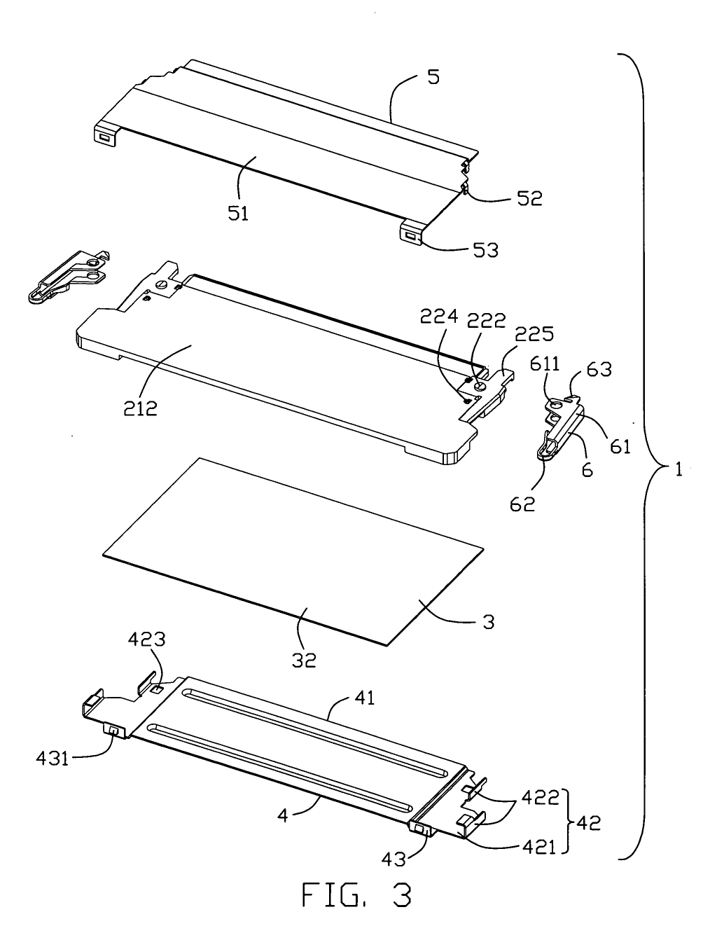

Referring to FIGS. 1 to 3, a cable assembly 1 in accordance with the present invention includes an insulative housing 2, a flexible flat cable 3 supported by the insualtive housing 2, an upper and a lower shell 4, 5 respectively assembled to the insulative housing 2 and a pair of latch members 6 respectively assembled to the two sides of the insulative housing 2.

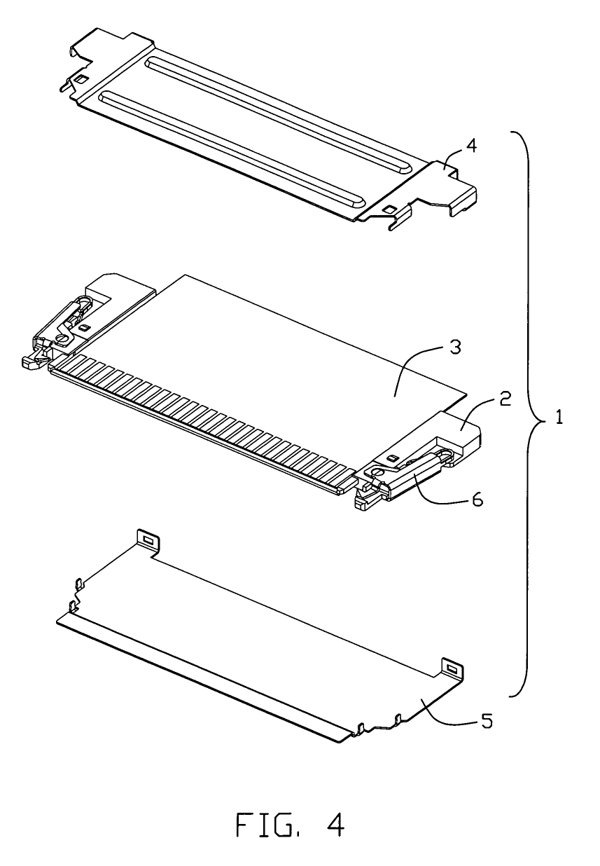

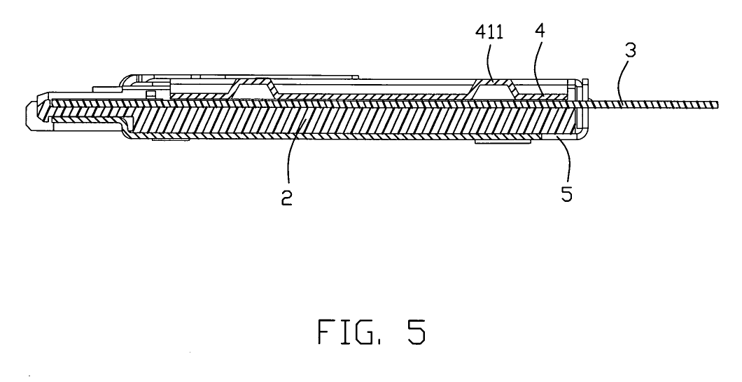

Referring to FIGS. 1 to 5, the insulative housing 2 includes a supporting portion 21 for supporting the flexible flat cable 3 and a pair of fixing portions 22 disposed at two sides thereof for mounting the two latch members 6 thereon. The supporting portion 21 defines an upper surface 211 for attaching the flexible flat cable 3 and a lower surface 212 opposite to the upper surface 21. A lengthwise rib 213 is formed at the front end of the supporting portion 21 extending upwardly from the upper surface 211. Thus, the flexible flat cable 3 is stopped by the rib 213 which is moved from back to front. Each fixing portion 22 defines a L-shaped groove 221 recessed from a top surface and a side surface thereof, a pair of retaining posts 222 respectively formed on the top and bottom surface of the fixing portion 22 for mounting the latch member 6, a wedge-shaped block 223 defined on the top surface thereof and two spaced positioning slots 224 formed on the bottom suface thereof for positioning the lower shell 5. A guide rod 225 extends forwardly from the fixing portion 22 defining a block 226 extending upwardly thereon for preventing the latch member 6 swung inwardly. The upper surface 211 of the supporting portion 21 is lower than the top surface of the fixing portion 22 so that a receiving space is defined therebetween.

The flexible flat cable 3 defines a top and a bottom insulative layer 32, and a plurality of conductors 31 enveloped by the top and bottom insulative layer 32. The mating portions 311 of the conductors 31 are exposed out of the top insualtive layer 32 and can be mating with the terminals (not shown) in the complementary connector.

The upper and lower shell 4, 5 can be respectively stamped from a metal plate and covered to the insulative housing 2.

The upper shell 4 includes a main body portion 41, a pair of positioning portions 42 and a pair of engaging portions 43. The main body portion 41 defines two flanges 411 protruding upwardly and extending in a widthwise direction and attached to the flexible flat cable 3. The pair of positioning portions 42 extend upwardly and outwardly in turn from both sides of the main body portion 41 making the main body portion 41 lower than the two positioning portions 42. The positioning portion 42 of the upper shell 4 surrounded the fixing portion 22 defines a L-shaped horizontal portion 421 and two spaced tabs 422 bent downwardly from the side edge of the horizontal portion 421. The horizontal portion 421 of the positioning portion 42 is attched to the top surface of the fixing portion 22, defines a retaining hole 423 matched with the wedge-shaped block 223 of the fixing portion 22. The two spaced tabs 422 are also fitted around the fixing portion 22. The pair of engaging portions 43 extending downwardly from rear edge of the positioning portions 42 defines an emboss 431 thereon for engaging with the lower shell 5.

The lower shell 5 defines a base portion 51, four tabs 52 extending upwardly from both sides of the body portion 51 and a pair of latch portions 53 extending upwardly from two sides of the rear edge. The tabs 52 are received into the positioning slots 224 of the insulative housing 2 making the lower shell 5 engaged with the insulative housing 2. The latching portions 53 defines a hole 531 matched with the emboss 431 of the engaging portions 43.

The latch member 6 is stamped from a metal plate and assembled to the fixing portioin 22 of the insulative housing 2. The latch member 6 defines a operating portion 61, a resilient portion 62 extending rearwardly firstly and then turning back for a distance and a locking barb 63 extending forwardly from pressing 61 for latching with the complementary connector. The cross section of the operating portion 61 is generally U-shaped defining an opening toward to the side surface fixing portion 22. The operating portion 61 defines a top wall, a bottom wall and a side wall connected with the top wall and the bottom wall. Each top wall and bottom wall defines a hole 611 fitted with the corresponding retaining post 222 of the fixing portion 22. The slender resilient portion 62 is received into the L-shaped groove 221 and defines a distal portion 621 attched to the tabs 422 of the upper shell 4.

Referring to FIGS. 1 to 5, the assembling process of the cable assembly 1 in according to the present invention starts from assembling the flexible flat cable 3 on the upper surface 211 of the supporting portion 21 of the insulative housing 2 and making them engaged with each other by glue.

After the flexible flat cable 3 is assembled to the insulative housing 21, then assembling the upper shell 4 to the insulative housing 2. The main body portion 41 of the upper shell 4 is attached to the flexible flat cable 3 and received into the receiving space formed between the supporting portion 21 and the fixing portion 22. And the mating portions 311 of the conductors 31 of the flexible flat cable 3 are exposed out of the upper shell 4. The two positioning portions 42 of the upper shell 4 are fitted around a section of the fixing portion 22 of the insulative housing 2 and defines a retaining hole 423 engaged with the wedge-shaped block 223 of the fixing portion 22 making the upper shell 4 positioned to the insulative housing 2. The engaging portion 43 is attached to the rear surface of the fixing portion 22.

After the upper shell 4 is assembled to the insulative housing 21, then assembling the lower shell 5 to the insulative housing 2. Several tabs 52 of the lower shell 5 are received into the positioning slots 224 and making the lower shell 5 engaged with the insulative housing 21. The hole 531 of the latch portion 53 matched with the emboss 431 of the engaging portions 43 so that the upper shell 4 and the lower shell 5 are engaged with each other.

At last, assembling the pair of latch members 6 to the fixing portion 22 of the insulative housing 2. The hole 611 of the operating portion 61 is fitted with the retaining post 222 of the fixing portion 22 allowing the latch member 6 angular swung such that the operating portion 61 of the latch member 6 is mounted to the fixing portion 22. The resilient portion 62 is received into the L-shaped groove 221 and making the distal portion 621 thereof attached to the tabs 422 of the upper shell 4.

After the above assembling steps, the entire process of assembling the cable assembly 1 is finished.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What we claimed is:

1. A cable assembly, comprising:
an insulative housing defining a supporting portion with an upper surface and a pair of fixing portions disposed at two sides of the supporting portion with a top surface higher than the upper surface, and a receiving space defined by the supporting portion and the pair of fixing portions;
a flexible flat cable supported by the supporting portion of the insulative housing and received into the receiving space;
an upper shell assembled to the insualtive housing and defining a main body portion covering to the flexible flat cable and a pair of positioning portions respectively attached to the pair fixing portions thereof, the upper shell having a recessed main body portion relative to the pair of fixing portions and received into the receiving space; and
a pair of latch members respectively mounted on the pair of fixing portions.

2. The cable assembly as recited in claim 1, wherein the pair of positioning portions of the upper shell are both bent upwardly and outwardly from two sides of the main body portion.

3. The cable assembly as recited in claim 2, wherein each positioning portion comprises a L-shaped horizontal portion defining retaining hole and two spaced tabs bent downwardly from the side edge of the L-shaped horizontal portion.

4. The cable assembly as recited in claim 3, wherein each fixing portion defines a wedge-shaped block thereon received in the retaining hole, a pair of upright retaining posts respectively formed on the top and bottom surface thereof and a L-shaped groove recessed from the top surface and side surface thereof.

5. The cable assembly as recited in claim 4, wherein each latch member defines a operating portion having a pair of holes corresponding to the pair of retaining posts, a resilient portion extending rearwardly firstly and then turning back for a distance received in the L-shape groove and a locking barb extending forwardly from operating portion.

6. The cable assembly as recited in claim 1, wherein the cable assembly further defines a lower shell assemble to the insulative housing and engaged with the upper shell.

7. The cable assembly as recited in claim 6, wherein the lower shell defines a plurality of tabs disposed at two sides thereof and a pair of latch portion disposed at two sides of the rear edge thereof.

8. The cable assembly as recited in claim 7, wherein the insulative housing defines a plurality of positioning slots receiving the corresponding tabs of the lower shell.

9. The cable assembly as recited in claim 7, wherein the upper shell further defines a pair of engaging portions extending downwardly from rear edge of the positioning portions engaged with the pair of latch portion.

10. The cable assembly as recited in claim 1, wherein a lengthwise rib is formed at the front end of the supporting portion protruding upwardly and extending along a transverse direction for stopping the flexible flat cable moved forwardly.

11. The cable assembly as recited in claim 1, wherein the flexible flat cable is attached to the supporting portion of the insulative housing by glue.

12. The cable assembly as recited in claim 1, wherein the flexible flat cable defines a top insulative layer, a bottom insulative layer and a plurality of conductors enveloped by the top and bottom insulative layer.

13. The cable assembly as recited in claim 12, wherein each conductor defnes a mating portion exposed out of the top insualtive layer.

14. The cable assembly as recited in claim 1, wherein the main body portion of the upper shell defines two flanges protruding upwardly and extending in a widthwise direction.

15. A cable assembly, comprising:
an insulative housing defining a recess area in a middle portion thereof;
a flexible flat cable received into the recess area;
an upper shell comprising a main body portion accommodated in the recess area to shield the flexible flat cable and a pair of fixing portions connecting with lateral sides of the main body portion and engaging with the insulative housing; and
a pair of latch members respectively mounted on two side portions of the insualtive housing.

16. The cable assembly as recited in claim 15, wherein the cable assembly further comprising a lower shell covering a bottom surface of the insulative housing.

17. The cable assembly as recited in claim 16, wherein the upper shell latches with the lower shell.

18. A cable connector assembly comprising:
an insulative housing defining an upward middle supporting portion with a pair of fixing portions raised upwardly with regard to the supporting portion;
a flexible flat cable (FFC) positioned upon an upper surface of the supporting;
an upper shell defining a middle main portion seated upon the FFC so as to cooperate with the supporting portion to sandwich said FFC therebetween, and a pair of positioning portions raised upwardly with regard to the middle main portion and securely seated upon the pair of fixing portions of the housing, respectively; and
a bottom shell defining a base portion directly abutting against an undersurface of the supporting portion; wherein
the base portion includes a front section upwardly offset from remainders and received in a recess formed in a front area of said undersurface of the supporting portion.

19. The cable connector assembly as claimed in claim 18, further including a pair of latches pivotally mounted upon the pair of fixing portions.

20. The cable connector assembly as claimed in claim 19, wherein each of said pair of latches defines a structure sandwiching the corresponding fixing portion therebetween in an up-and-down direction.
